(19) United States
(12) Patent Application Publication
(10) Pub. No.: US 2025/0004815 A1
(43) Pub. Date: Jan. 2, 2025

(54) CONTAINER AUTO SCALING BASED ON COMPONENT DEPENDENCY

(71) Applicant: VMWARE, INC, Palo Aito, CA (US)

(72) Inventors: AGNELLO LLOYED NORONHA, Bangalore (IN); Sameer Chandra Tatiraju, Bangalore (IN); Manish Balchand Jain, Bangalore (IN)

(21) Appl. No.: 18/370,408

(22) Filed: Sep. 20, 2023

(30) Foreign Application Priority Data
Jun. 30, 2023 (IN) 202341044155

(51) Int. Cl. G06F 9/455; G06F 9/52

(52) U.S. Cl. CPC G06F 9/45558; G06F 9/52; G06F 2009/4557

(57) ABSTRACT

The disclosure provides a method for scaling dependent objects running in a container cluster based on scaling of a first object running in the container cluster. The method generally includes determining to scale the first object. The method further includes determining one or more first dependent objects that depend from the first object. The method further includes, for each of the one or more first dependent objects: determining a corresponding scaling value; determining whether to scale the corresponding first dependent object based on the corresponding scaling value; and scaling the corresponding first dependent object when determined to scale the corresponding first dependent object.

### RELATED APPLICATIONS

Benefit is claimed under 35 U.S.C. 119 (a)-(d) to Foreign application No. 202341044155 filed in India entitled “CONTAINER AUTO SCALING BASED ON COMPONENT DEPENDENCY”, on Jun. 30, 2023, by VMware, Inc., which is herein incorporated in its entirety by reference for all purposes.

Modern applications are applications designed to take advantage of the benefits of modern computing platforms and infrastructure. For example, modern applications can be deployed in one or more cloud or on-premises data centers onto one or more virtual machines (VMs), containers, application services, and/or the like.

A container is a package that relies on virtual isolation to deploy and run applications that depend on a shared operating system (OS) kernel. Containerized applications (also referred to as “containerized workloads”), can include a collection of one or more related applications packaged into one or more containers. In some orchestration systems, a set of one or more related containers sharing storage and network resources, referred to as a pod, are deployed as a unit of computing software. Container orchestration systems automate the lifecycle of containers, including such operations as provisioning, deployment, monitoring, scaling (up and down), networking, and load balancing.

Kubernetes® (K8S®) software is an example open-source container orchestration platform that automates the deployment and operation of such containerized applications. At a high level, the Kubernetes platform is made up of a central database containing Kubernetes objects, or persistent entities, that are managed in the platform. Kubernetes objects are represented in configuration files, such as JavaScript Object Notation (JSON) or YAML files, and describe the intended state of a Kubernetes cluster of interconnected nodes used to run containerized applications. A node may be a physical machine, or a VM configured to run on a physical machine running a hypervisor. The intended state of the cluster includes intended infrastructure (e.g., pods, containers, etc.) and containerized applications that are to be deployed in the cluster. In other words, a Kubernetes object is a “record of intent”—once an object is created, the Kubernetes system (e.g., a controller of the Kubernetes cluster) will constantly work to ensure that object is realized in the deployment. The Kubernetes objects, accordingly, may be processes that run on nodes of the cluster.

There are two categories of objects in Kubernetes: native Kubernetes objects and custom resource definition (CRD) objects (also referred to herein as “custom resources”). Native Kubernetes objects include pods, services, volumes, namespaces, deployments, load balancers, replication controllers, ReplicaSets, and/or the like which are supported and can be created/manipulated by a Kubernetes application programming interface (API). The Kubernetes API is a resource-based (e.g., RESTful or representational state transfer architectural style) programmatic interface provided via HTTP. A CRD object, on the other hand, is an object that extends the Kubernetes API or allows a user to introduce their own API into a Kubernetes cluster.

A controller of the Kubernetes cluster may be configured to auto scale objects running in the cluster. Objects herein may refer to Kubernetes objects, as defined above, or other similar objects of other container orchestration platforms. Auto scaling of an object may refer to the automatic increase or decrease in a number of instances of the object deployed in the cluster, such as based on one or more criteria. For example, the controller may implement a horizontal pod autoscaler (HPA) and/or a vertical pod autoscaler (VPA). These autoscalers are designed to help guarantee availability in Kubernetes by providing automatic scalability of objects to adapt to varying load.

The HPA is a tool designed to automatically update workload resources, such as Deployments and StatefulSets (e.g., designed to manage the deployment and scaling of a set of Pods), scaling them to match the demand for applications in a container-based cluster. Horizontal scaling refers to the process of deploying additional pods in the cluster in response to increased load and/or removing pods in the container-based cluster in response to decreased load. In some cases, the HPA is designed to automatically increase and/or decrease the number of pod replicas in the cluster based on actual usage metrics, such as central processing unit (CPU) and/or memory utilization. In certain embodiments, the HPA is implemented as a control loop to scale pod replicas based on the ratio between desired metric values and current metric values. The choice of desired usage metric values imposes a tradeoff between application availability and operation costs.

The VPA is a tool designed to automatically adjust resource limits and/or resource requests (e.g., with respect to CPU and/or memory) to help ensure that pods are operating efficiently at all times. The VPA determines the adjustment by analyzing historic memory and/or CPU usage, as well as current memory and/or CPU usage, by containers running in pods. In certain embodiments, the VPA provides recommended values for resource requests and/or limits that a user can use to manually update the configuration. In certain cases, the VPA automatically updates the configuration based on these recommended values.

### SUMMARY

One or more embodiments provide a method for scaling dependent objects running in a container cluster based on scaling of a first object running in the container cluster. The method generally includes determining to scale the first object. The method further includes determining one or more first dependent objects that depend from the first object. The method further includes, for each of the one or more first dependent objects: determining a corresponding scaling value; determining whether to scale the corresponding first dependent object based on the corresponding scaling value; and scaling the corresponding first dependent object when determined to scale the corresponding first dependent object.

Further embodiments include one or more non-transitory computer-readable storage media comprising instructions that cause a computer system to carry out the above methods, as well as a computer system configured to carry out the above methods.

### BRIEF DESCRIPTION OF THE DRAWINGS

FIG. 1A illustrates a computing system in which embodiments described herein may be implemented.

FIG. 1B illustrates an example container-based cluster for running containerized applications in the computing system of FIG. 1A, according to an example embodiment of the present disclosure.

FIG. 2 illustrates an example of object dependency, according to an example embodiment of the present disclosure.

FIG. 3 illustrates an example method for auto scaling dependent objects, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

As discussed, objects, such as pods may be auto scaled, such as when resource utilization of the object reaches a threshold. However, such auto scaling is static in nature, and does not consider dependency between objects. For example, an application (e.g., deployed as one or more instances of the application, each instance being a pod) may be dependent on a load balancer. In particular, a load balancer may receive requests for an application, and determine an instance of the application to which to direct the request. Accordingly, an increased load on the load balancer, such as an increased rate of receiving requests for the application at the load balancer, may lead to an increased load on the application. In particular, the load balancer may send requests at an increased rate to the application, thereby increasing the load at the application for processing the requests. Therefore, the application is dependent on the load balancer, as the load on the application is dependent on the load on the load balancer.

The increased load on the load balancer may cause auto scaling of the load balancer. For example, the increased rate of receiving requests at the load balancer may cause an increased memory and/or CPU utilization at the load balancer, and therefore a controller of the cluster may auto scale the load balancer, such as by deploying additional instances of the load balancer, or increasing a resource limit of the load balancer. Such auto scaling of the load balancer, however, may not cause any auto scaling of objects dependent on the load balancer, which may cause temporary congestion at objects dependent on the load balancer. For example, when the number of instances of the load balancer is increased, the load balancer may be able to process more requests and send those requests at a higher rate to the application. Accordingly, the load on the application increases, which may cause temporary congestion at the application when the application has not been auto scaled. For example, only after the application experiences congestion, such as through increased memory and/or CPU utilization, would the application be auto scaled. Accordingly, there is a technical problem in that dependent objects may experience congestion, latency, etc., based on the scaling of the objects from which they depend.

Accordingly, techniques are provided herein for auto scaling dependent objects based on the scaling of the objects from which they depend. For example, if a first object is scaled, an object dependent on the first object may also be scaled. In certain aspects, a dependent object that depends from another object may be associated with a scaling value. In certain aspects, the scaling value indicates the likelihood or probability that the dependent object should be scaled based on the scaling of the object from which the dependent object depends. In certain aspects, the scaling value indicates, such as using a binary value, whether or not the dependent object should be scaled based on the scaling of the object from which the dependent object depends. In certain aspects, the scaling value is a target ratio indicating the target ratio of the number of dependent objects to the number of objects from which the dependent object depends. Accordingly, the number of dependent objects may be scaled based on trying to maintain the target ratio after the number of objects from which the dependent object depends is scaled. Whether a dependent object is scaled based on the scaling of the object from which the dependent object depends may be based on the scaling value. By scaling dependent objects dynamically based on the scaling of the objects from which they depend, congestion at the dependent objects can be avoided, thereby providing a technical solution to the technical problem.

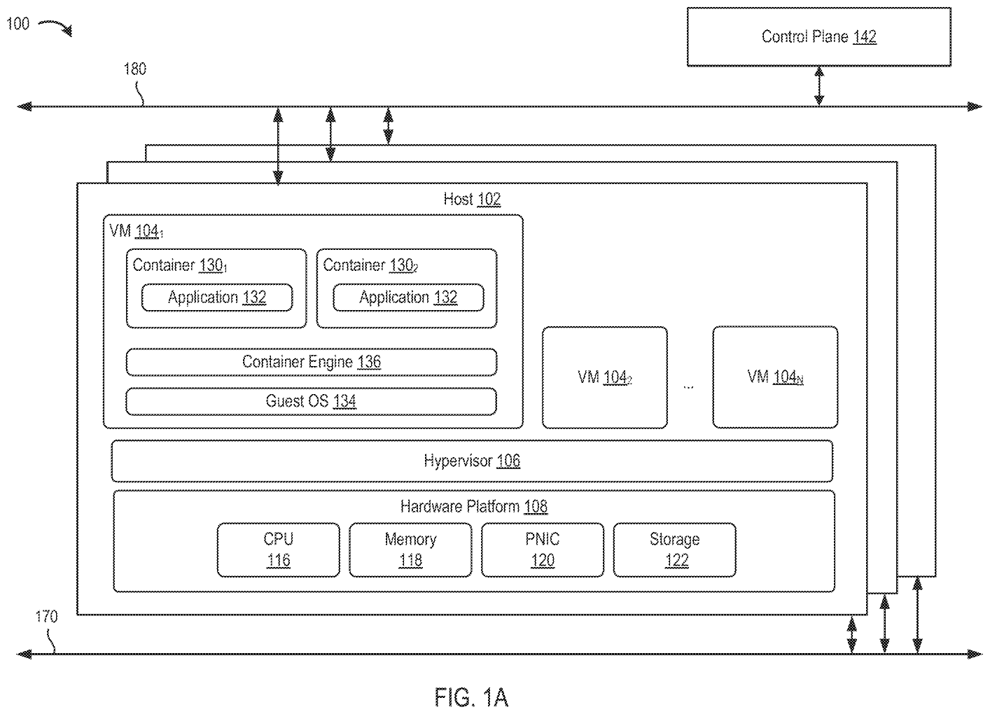

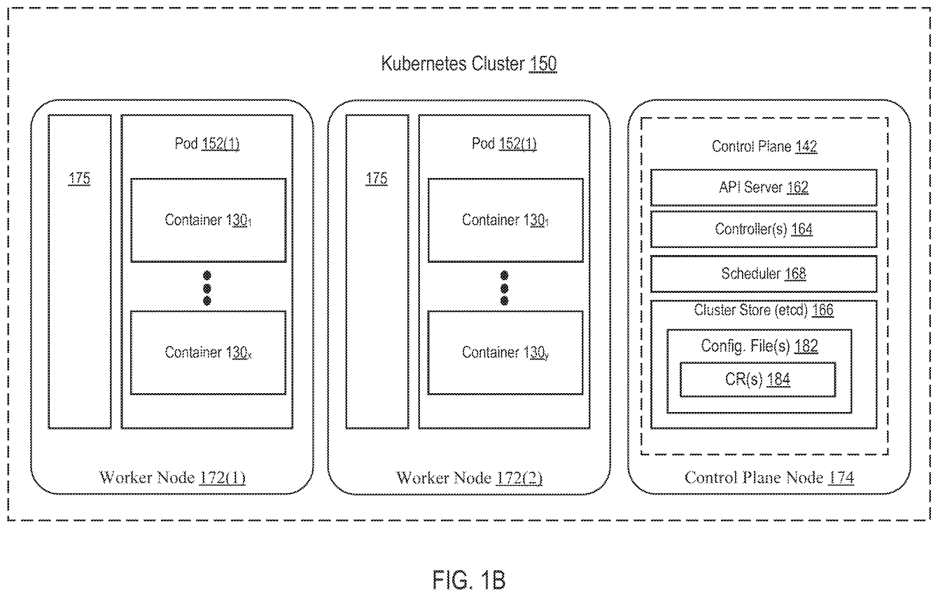

FIG. 1A is a block diagram that illustrates a computing system 100 in which embodiments described herein may be implemented. Computing system 100 includes one or more hosts 102, a management network 180, and a data network 170.

Host(s) 102 may be geographically co-located servers on the same rack or on different racks in any arbitrary location in the data center. Host(s) 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 1041 to 104x (collectively referred to as VMs 104 and individually referred to as VM 104) that run concurrently on the same host 102.

Host(s) 102 may be constructed on a server grade hardware platform 108, such as an x86 architecture platform. Hardware platform 108 of each host 102 includes components of a computing device such as one or more processors (central processing units (CPUs)) 116, memory (random access memory (RAM)) 118, one or more network interfaces (e.g., physical network interfaces (PNICs) 120), storage 122, and other components (not shown). CPU 116 is configured to execute instructions that may be stored in memory 118, and optionally in storage 122. The network interface(s) enable hosts 102 to communicate with other devices via a physical network, such as management network 180 and data network 170.

In certain embodiments, hypervisor 106 runs in conjunction with an operating system (OS) (not shown) in host 102. In some embodiments, hypervisor 106 can be installed as system level software directly on hardware platform 108 of host 102 (often referred to as “bare metal” installation) and be conceptually interposed between the physical hardware and the guest OSs executing in the VMs 104. It is noted that the term “operating system,” as used herein, may refer to a hypervisor. One example of hypervisor 106 that may be configured and used in embodiments described herein is a VMware ESXi™ hypervisor provided as part of the VMware vSphere® solution made commercially available by VMware, Inc. of Palo Alto, CA.

Each of VMs 104 implements a virtual hardware platform that supports the installation of a guest OS 134 which is capable of executing one or more applications 132. Guest OS 134 may be a standard, commodity operating system. Examples of a guest OS include Microsoft Windows, Linux, and/or the like. Applications 132 may be any software program, such as a word processing program.

In certain embodiments, computing system 100 includes a container orchestrator. The container orchestrator implements a container orchestration control plane (also referred to herein as the “control plane 142”), such as a Kubernetes control plane, to deploy and manage applications 132 and/or services thereof on hosts 102 using containers 130. In particular, each VM 104 includes a container engine 136 installed therein and running as a guest application under control of guest OS 134. Container engine 136 is a process that enables the deployment and management of virtual instances, referred to herein as “containers,” in conjunction with OS-level virtualization on guest OS 134 within VM 104 and the container orchestrator. Containers 130 provide isolation for user-space processes executing within them. Containers 130 encapsulate an application (and its associated applications 132) as a single executable package of software that bundles application code together with all of the related configuration files, libraries, and dependencies required for it to run.

Control plane 142 runs on a cluster of hosts 102 and may deploy containerized applications 132 as containers 130 on the cluster of hosts 102. Control plane 142 manages the computation, storage, and memory resources to run containers 130 in the host cluster. In certain embodiments, hypervisor 106 is integrated with control plane 142 to provide a “supervisor cluster” (i.e., management cluster) that uses VMs 104 to implement both control plane nodes and compute objects managed by the Kubernetes control plane.

In certain embodiments, control plane 142 deploys and manages applications as pods of containers 130 running on hosts 102, either within VMs 104 or directly on an OS of hosts 102. A pod is a group of one or more containers 130 and a specification for how to run the containers 130. A pod may be the smallest deployable unit of computing that can be created and managed by control plane 142.

An example container-based cluster for running containerized applications is illustrated in FIG. 1B. While the example container-based cluster shown in FIG. 1B is a Kubernetes cluster 150, in other examples, the container-based cluster may be another type of container-based cluster based on container technology, such as Docker Swarm clusters. As illustrated in FIG. 1B, Kubernetes cluster 150 is formed from a cluster of interconnected nodes, including (1) one or more worker nodes 172 that run one or more pods 152 having containers 130 and (2) one or more control plane nodes 174 having control plane components running thereon that control the cluster (e.g., where a node is a physical machine, such as a host 102, or a VM 104 configured to run on a host 102).

Each worker node 172 includes a kubelet 175. Kubelet 175 is an agent that helps to ensure that one or more pods 152 run on each worker node 172 according to a defined state for the pods 152, such as defined in a configuration file. Each pod 152 may include one or more containers 130. The worker nodes 172 can be used to execute various applications 132 and software processes using containers 130. Further, each worker node 172 may include a kube proxy (not illustrated in FIG. 1B). A kube proxy is a network proxy used to maintain network rules. These network rules allow for network communication with pods 152 from network sessions inside and/or outside of Kubernetes cluster 150.

Control plane 142 (e.g., running on one or more control plane nodes 174) includes components such as an application programming interface (API) server 162, controller(s) 164, a cluster store (etcd) 166, and scheduler(s) 168. Control plane 142's components make global decisions about Kubernetes cluster 150 (e.g., scheduling), as well as detect and respond to cluster events.

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. The kube-apiserver is designed to scale horizontally—that is, this component scales by deploying more instances. Several instances of kube-apiserver may be run, and traffic may be balanced between those instances.

Controller(s) 164 is responsible for running and managing controller processes in Kubernetes cluster 150. As described above, control plane 142 may have (e.g., four) control loops called controller processes, which watch the state of Kubernetes cluster 150 and try to modify the current state of Kubernetes cluster 150 to match an intended state of Kubernetes cluster 150.

Scheduler(s) 168 is configured to allocate new pods 152 to worker nodes 172.

Cluster store (etcd) 166 is a data store, such as a consistent and highly-available key value store, used as a backing store for Kubernetes cluster 150 data. In certain embodiments, cluster store (etcd) 166 stores configuration file(s) 182, such as JavaScript Object Notation (JSON) or YAML files, made up of one or more manifests that declare intended system infrastructure and workloads to be deployed in Kubernetes cluster 150. Kubernetes objects, or persistent entities, can be created, updated and deleted based on configuration file(s) 182 to represent the state of Kubernetes cluster 150.

A Kubernetes object is a “record of intent”-once an object is created, the Kubernetes system will constantly work to ensure that object is realized in the deployment. One type of Kubernetes object is a custom resource definition (CRD) object (also referred to herein as a “custom resource (CR) 184”) that extends API server 162 or allows a user to introduce their own API into Kubernetes cluster 150. In particular, Kubernetes provides a standard extension mechanism, referred to as custom resource definitions, that enables extension of the set of resources and objects that can be managed in a Kubernetes cluster.

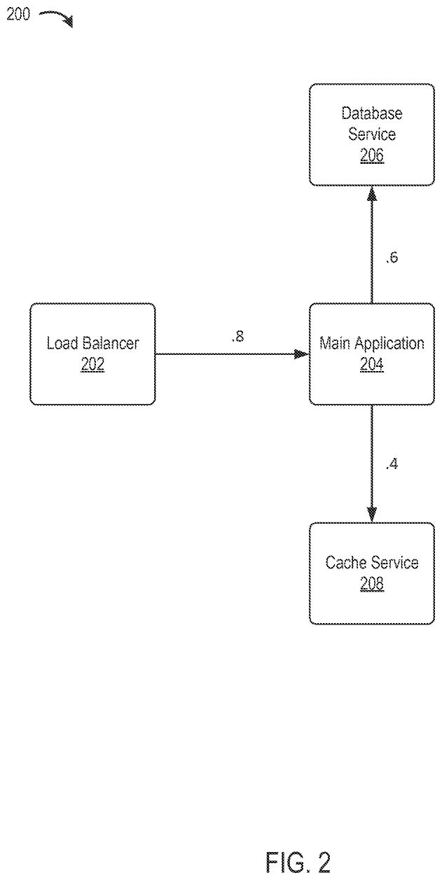

FIG. 2 illustrates a graph 200 showing dependencies between a load balancer 202, a main application 204, a database service 206, and a cache service 208, each of which may run in a container cluster, such as Kubernetes cluster 150. For example, each of load balancer 202, main application 204, database service 206, and cache service 208 may run as one or more containers or pods.

In certain aspects, graph 200 is a probabilistic graph model (PGM). A PGM is a mathematical framework for representing complex probability distributions. It uses a graph-based representation to encode the conditional dependencies between random variables. The graph structure of a PGM provides a visual and intuitive way to understand the relationships between the variables in the model.

There are two main types of PGMs: Bayesian networks and Markov networks. Bayesian networks represent the dependencies between variables using directed acyclic graphs (DAGs), while Markov networks use undirected graphs. Both types of models can be used to represent joint probability distributions over multiple variables and to perform probabilistic inference.

In graph 200, each node represents an object (i.e., load balancer 202, main application 204, database service 206, and cache service 208) and each edge represents the conditional dependences between the objects. In particular, in graph 200, an edge represents the conditional dependency that the scaling of one object depends on the scaling of another object. In particular, each edge is associated with a scaling value, as discussed. When graph 200 is a PGM, a scaling values indicates a probability that one object should be scaled when another object is scaled. For another example graph 200, a scaling value may be a binary value indicating whether or not the dependent object should be scaled based on the scaling of the object from which the dependent object depends. For another example graph 200, a scaling value may be a target ratio indicating the target ratio of the number of dependent objects to the number of objects from which the dependent object depends. As shown, main application 204 depends from load balancer 202. Further each of database service 206 and cache service 208 depends from main application 204.

According to graph 200, the edge between load balancer 202 and main application 204 is associated with a scaling value of 0.8. In this example, the scaling value 0.8 represents a 0.8 probability (i.e., 80% probability) that if load balancer 202 is scaled, main application 204 should be scaled. For example, an additional instance of load balancer 202 may be deployed by controller 164 implementing HPA due to load balancer 202 having a resource utilization over a threshold. Accordingly, there may be an 80% probability that application 204 may experience congestion due to the additional instance of load balancer 202 being deployed. Therefore, there is an 80% probability that main application 204 should be scaled, such as by deploying an additional instance of main application 204. Similarly, according to graph 200, the edge between main application 204 and database service 206 is associated with a scaling value of 0.6, and the edge between main application 204 and cache service 208 is associated with a scaling value of 0.4. Therefore, graph 200 represents the dependencies between objects in a cluster, including the scaling values associated with each dependency.

Certain aspects are discussed herein with respect to a PGM as the data structure used to represent the dependencies between objects in a cluster, including the scaling values associated with each dependency. However, it should be noted that other data structures, such as other types of graphs, tables, lists, etc., may be used to represent the dependencies between objects in a cluster, including the scaling values associated with each dependency.

Further, certain aspects are discussed herein with respect to HPA in that a number of instances of an object are increased or decreased. However, it should be understood that VPA may additionally or alternatively used for scaling objects. For example, load balancer 202 may be scaled using HPA, such that one or more additional instances of load balancer 202 are deployed. Accordingly, main application 204 may be scaled using HPA, such that one or more additional instance of main application 204 are deployed, and/or may be scaled using VPA, such that additional resources are allocated to main application 204. Similarly, load balancer 202 may be scaled using VPA, such that additional resources are allocated to load balancer 202. Accordingly, main application 204 may be scaled using HPA and/or VPA.

In certain aspects, the same scaling values, and accordingly graph, may be used for both scaling up objects and scaling down objects. For example, there may be an 80% probability that an additional instance of main application 204 should be deployed if an additional instance of load balancer is deployed. Further, there may also be an 80% probability that an instance of main application 204 should be removed if an instance of load balancer is removed from the cluster.

In certain other aspects, different scaling values, such as different graphs, may be used for scaling up objects and scaling down objects. For example, there may be an 80% probability that an additional instance of main application 204 should be deployed if an additional instance of load balancer is deployed. However, there may be a 60% probability that an instance of main application 204 should be removed if an instance of load balancer is removed from the cluster.

In certain aspects, the scaling values between objects may be determined manually, such as by an experienced administrator that understands the likelihood that one object depends on another object. In certain other aspects, the scaling values between objects may be determined using machine learning techniques or other techniques.

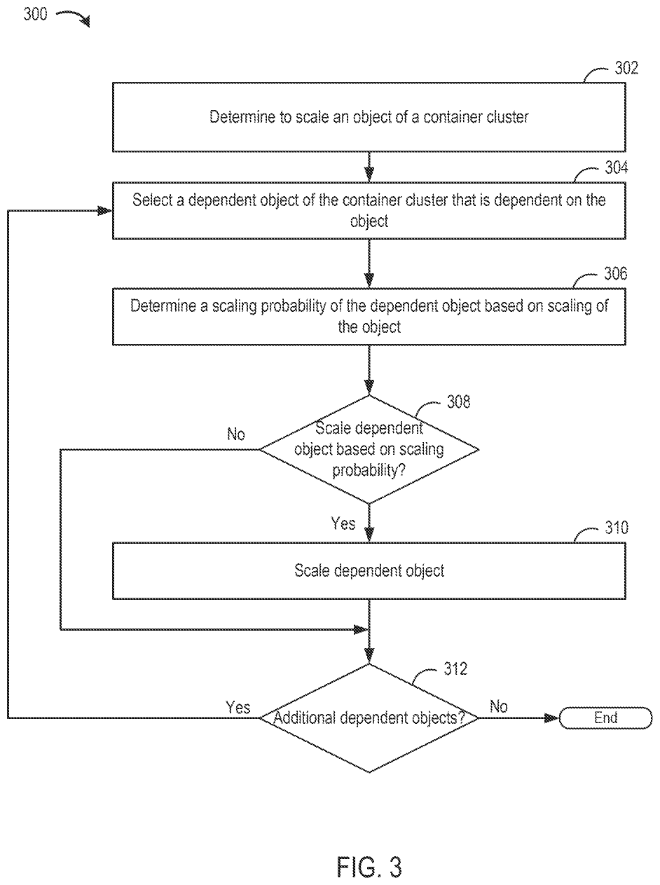

FIG. 3 illustrates an example method 300 for auto scaling dependent objects, according to an example embodiment of the present disclosure. Method 300 may be performed by control plane 142, such as by controller 164. Aspects of method 300 are described with respect to controller 164 using graph 200 to scale the objects represented by graph 200. However, method 300 may similarly be used for auto scaling any depending objects in a container cluster, the dependency being represented by any suitable data structure.

As illustrated in FIG. 3, method 300 begins, at operation 302, with determining to scale an object of a container cluster. For example, controller 164 may determine to scale an object using HPA and/or VPA, such as where a resource utilization of the object meets a threshold or limit. For example, the object may be associated with a resource utilization limit at which to scale up the object for each of one or more resources (e.g., CPU, memory, etc.). If the utilization of the resource exceeds the limit, the object may be scaled up using HPA and/or VPA. As another example, the object may be associated with a resource utilization limit (different than the resource utilization limit for scaling up the object), at which to scale down the object for each of one or more resources. If the utilization of the resource is below the limit, the object may be scaled down using HPA and/or VPA.

As an illustrative example, controller 164 determines that an additional instance of load balancer 202 should be deployed.

Continuing, at operation 304, a dependent object that is dependent on the object determined to be scaled is selected. For example, controller 164 selects main application 204 that is dependent on load balancer 202 according to graph 200.

Further, at operation 306, a scaling value of the dependent object with respect to the object is determined. For example, controller 164 determines the scaling value for scaling main application 204 based on scaling load balancer 202 is 0.8 according to graph 200.

At operation 308, controller 164 determines whether to scale the dependent object based on at least the scaling value.

In certain aspects, controller 164 is configured to determine whether the scaling value is greater than a threshold (e.g., 50%). In certain aspects, if the scaling value is greater than the threshold, controller 164 determines to scale the dependent object. In certain aspects, if the scaling value is less than the threshold, controller 164 determines not to scale the dependent object.

In certain aspects, instead of scaling values being a range of percentage from 0-100%, scaling values may be binary as in 0 (e.g., do not scale) or 1 (e.g., scale), such that the dependent object is scaled if the scaling value has one value (e.g., 1) and is not scaled if the scaling value has another value (e.g., 0). For example, the graph 200 may have the values 0 or 1, instead of a range of percentage from 0-100%.

In certain aspects, controller 164 is configured to determine whether to scale the dependent object further based on a replica count (referred to as “Y”) of the dependent object, and/or the replica count (referred to as “X”) of the object from which it depends. The replica count indicates how many instances of an object are deployed. In certain aspects, the controller 164 is configured to scale up the dependent object when the object from which it depends is scaled up as long as the following inequality is true: Y/X<scaling value. Further, in certain aspects, the controller 164 is configured to scale down the dependent object when the object from which it depends is scaled down as long as the following inequality is true: Y/X>scaling value.

For example, where a number of replicas of load balancer 202 is scaled up, controller 164 may be configured to deploy additional instances of main application 204 so long as a number of replicas of the main application 204 divided by a number of replicas of the load balancer 202 is less than 0.8.

As another example, where a number of replicas of load balancer 202 is scaled down, controller 164 may be configured to remove instances of main application 204 so long as a number of replicas of the main application 204 divided by a number of replicas of the load balancer 202 is greater than 0.8.

If it is determined to scale the dependent object at operation 308, at operation 310, controller 164 scales the dependent object. For example, controller 164 changes a number of replicas of the dependent object and/or a resource allocation of the dependent object by changing a configuration of the dependent object and the control plane causes the change according to the configuration change as discussed.

If it is determined not to scale the dependent object at operation 308, the method 300 continues to operation 312. At operation 312 it is determined if there are any other objects dependent on the object being scaled. If there are additional dependent objects, method 300 returns to operation 304 to select such dependent objects. If there are no additional dependent objects, method 300 ends.

It should be noted that the object from which the dependent object depends may be scaled by controller 164 at any suitable point during method 300. For example, load balancer 202 may be scaled at any suitable time, such as at operation 302, after method 300 ends, at operation 310, etc.

It should further be noted that scaling of one object, such as load balancer 202, may cause scaling of another object, such as main application 204. Accordingly, method 300 may again be performed for main application 204 as the object being scaled, and for determining whether to scale dependent objects database service 206 and cache service 208.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for scaling dependent objects running in a container cluster based on scaling of a first object running in the container cluster, the method comprising:
determining to scale the first object;
determining one or more first dependent objects that depend from the first object; and
for each of the one or more first dependent objects:
determining a corresponding scaling value;
determining whether to scale the corresponding first dependent object based on the corresponding scaling value; and
scaling the corresponding first dependent object when determined to scale the corresponding first dependent object.

2. The method of claim 1, wherein the determining the one or more first dependent objects and for each of the one or more first dependent objects, the determining the corresponding scaling value is based on a probabilistic graph model indicating dependencies between objects in the container cluster.

3. The method of claim 1, wherein determining to scale the first object is based on a resource utilization by the first object.

4. The method of claim 1, wherein determining whether to scale the corresponding first dependent object based on the corresponding scaling value comprises determining whether to scale the corresponding first dependent object based on whether the corresponding scaling value satisfies a threshold.

5. The method of claim 1, wherein determining whether to scale the corresponding first dependent object is further based on a replica count of the corresponding first dependent object and a replica count of the first object.

6. The method of claim 1, wherein scaling the corresponding first dependent object comprises scaling a number of instances of the first dependent object.

7. The method of claim 1, wherein scaling the corresponding first dependent object comprises scaling a resource allocation of the first dependent object.

8. One or more non-transitory computer-readable media comprising instructions, which when executed by one or more processors, cause the one or more processors to perform operations for scaling dependent objects running in a container cluster based on scaling of a first object running in the container cluster, the operations comprising:
determining to scale the first object;
determining one or more first dependent objects that depend from the first object; and
for each of the one or more first dependent objects:
determining a corresponding scaling value;
determining whether to scale the corresponding first dependent object based on the corresponding scaling value; and
scaling the corresponding first dependent object when determined to scale the corresponding first dependent object.

9. The one or more non-transitory computer-readable media of claim 8, wherein the determining the one or more first dependent objects and for each of the one or more first dependent objects, the determining the corresponding scaling value is based on a probabilistic graph model indicating dependencies between objects in the container cluster.

10. The one or more non-transitory computer-readable media of claim 8, wherein determining to scale the first object is based on a resource utilization by the first object.

11. The one or more non-transitory computer-readable media of claim 8, wherein determining whether to scale the corresponding first dependent object based on the corresponding scaling value comprises determining whether to scale the corresponding first dependent object based on whether the corresponding scaling value satisfies a threshold.

12. The one or more non-transitory computer-readable media of claim 8, wherein determining whether to scale the corresponding first dependent object is further based on a replica count of the corresponding first dependent object and a replica count of the first object.

13. The one or more non-transitory computer-readable media of claim 8, wherein scaling the corresponding first dependent object comprises scaling a number of instances of the first dependent object.

14. The one or more non-transitory computer-readable media of claim 8, wherein scaling the corresponding first dependent object comprises scaling a resource allocation of the first dependent object.

15. A computer system comprising: one or more memories; and one or more processors configured to perform operations for scaling dependent objects running in a container cluster based on scaling of a first object running in the container cluster, the operations comprising:
determining to scale the first object;
determining one or more first dependent objects that depend from the first object; and
for each of the one or more first dependent objects:
determining a corresponding scaling value;
determining whether to scale the corresponding first dependent object based on the corresponding scaling value; and
scaling the corresponding first dependent object when determined to scale the corresponding first dependent object.

16. The computer system of claim 15, wherein the determining the one or more first dependent objects and for each of the one or more first dependent objects, the determining the corresponding scaling value is based on a probabilistic graph model indicating dependencies between objects in the container cluster.

17. The computer system of claim 15, wherein determining to scale the first object is based on a resource utilization by the first object.

18. The computer system of claim 15, wherein determining whether to scale the corresponding first dependent object based on the corresponding scaling value comprises determining whether to scale the corresponding first dependent object based on whether the corresponding scaling value satisfies a threshold.

19. The computer system of claim 15, wherein determining whether to scale the corresponding first dependent object is further based on a replica count of the corresponding first dependent object and a replica count of the first object.

20. The computer system of claim 15, wherein scaling the corresponding first dependent object comprises scaling a number of instances of the first dependent object.
